(19) United States
(12) Patent Application Publication
(10) Pub. No.: US 2016/0263618 A1
(43) Pub. Date: Sep. 15, 2016

(54) METHOD OF LIGHT-PROTECTION TEXTILE MATERIAL

(71) Applicant: Carl Freudenberg KG, Weinheim (DE)

(72) Inventors: Robert Groten, Sundhoffen (FR); Guenter Schmitt, Weinheim (DE)

(21) Appl. No.: 15/162,644

(22) Filed: May 24, 2016

Related U.S. Application Data
(63) Continuation of application No. 14/378,329, filed on Aug. 13, 2014.

(30) Foreign Application Priority Data
Feb. 16, 2012 (DE) 10 2012 002 954.3

(51) Int. Cl. B05D 3/00

(52) U.S. Cl. CPC B05D 3/007; A45B 23/00

(57) ABSTRACT

A method of protecting a textile material from light involves combining at least one crystallization auxiliary with a micro-filament non-woven fabric having a surface weight of 20 to 300 g/m², wherein the non-woven fabric comprises composite filaments that are melt-spun and plaited as a non-woven fabric having a titer of 1.5 to 5 decitex and the composite filaments are split into at least 80% of elementary filaments having a titer of 0.05 to 2.0 and are solidified, and wherein the elementary filaments have the at least one crystallization auxiliary including titanium dioxide, silicon dioxide, magnesium silicate hydrate, in particular in the form of talcum and/or aluminum silicate, in particular in the form of kaolin, in each case in an amount of 0.2 to 5 wt %.

### CROSS-REFERENCE TO RELATED APPLICATIONS

This application is a continuation of U.S. application Ser. No. 14/378,329, which entered the U.S. national stage under 35 U.S.C. §371 on Aug. 13, 2014, as PCT/EP2013/000402 filed on Feb. 12, 2013, claiming benefit to German Patent Application No. DE 10 2012 002 954.3, filed on Feb. 16, 2012. The International Application was published in German on Aug. 22, 2013, as WO 2013/120599 A1 under PCT Article 21(2).

### FIELD

The invention relates to a textile light-protection material, comprising a microfilament non-woven fabric having a surface weight of 20 to 300 g/m², and to the use thereof in outdoor applications, in particular for manufacturing parasols, outdoor curtains or roller-blinds, combined wind-protection and sun-protection materials and/or awnings.

### BACKGROUND

Textile light-protection materials are available in various embodiments. There is a basic distinction between soft and hard materials for this purpose. Clothing, drapes, curtains or roller blinds are often manufactured from soft textile materials, and vertical or horizontal blinds and fold-up roller-blinds are often manufactured from hard materials. Corresponding textile light-protection devices are also used for shielding from excessive incident light, for example in winter gardens. U.S. Pat. No. 5,436,064 discloses rigid textile composites which consist of a non-woven fabric made of thermoplastic material and a woven fabric, which are brought together, needled, and fused together by heating. Further, U.S. Pat. No. 5,600,974 discloses rigid textile composites which consist of non-woven fabrics through which yarns are knitted in a knitting machine. The non-woven fabric consists of two different fibers, one of which is thermoplastic and is melted on after knitting the yarns through. Further, the known textile composites can additionally be provided with a foamed material layer and are suitable for manufacturing vertical blinds, fold-up roller blinds, wall coverings or car interior linings.

It is also known to bind in titanium dioxide as a filter substance to increase the UV protection of fabrics. Thus, titanium dioxide may for example be incorporated into synthetic yarns during spinning.

The known light-protection materials have drawbacks relating to high material use, insufficient shielding against the incident light, in particular the UV component contained therein, or the photostability thereof. Furthermore, an expedient method of production is desirable.

DE 101053 discloses the use of a microfilament non-woven fabric having a surface weight of 20 to 300 g/m² as a textile light-protection material, wherein the non-woven fabric comprises multi-component continuous filaments which are melt-spun, stretched and directly plaited into a non-woven fabric having a titer of 1.5 to 5 dtex and (optionally after pre-solidification) at least 80% of the multi-component continuous filaments are split into elementary filaments having a titer of 0.05 to 2.0 dtex and are solidified. One example discloses the addition of titanium dioxide to increase the light-protection effect.

### SUMMARY

An aspect of the invention provides a method of light-protecting a textile, the method comprising: combining 0.2 to 5 wt. % of a crystallization agent with a microfilament non-woven fabric having a surface weight of 20 to 300 g/m2, wherein the microfilament non-woven fabric comprises composite filaments having a titer of 1.5 to 5 dtex which are melt-spun and plaited into a non-woven fabric, wherein at least 80% of the composite filaments are split into elementary filaments having a titer of 0.05 to 2.0 dtex and are solidified, wherein the elementary filaments comprise the crystallization agent, as a textile light-protection material, and wherein the crystallization agent comprises titanium dioxide, silicon dioxide, magnesium silicate hydrate, and/or aluminum silicate.

### DETAILED DESCRIPTION

An aspect of the invention provides a textile light-protection material which has an excellent light-protection effect combined with a high stability whilst being simple and cost-effective to manufacture.

According to an aspect of the invention, the object is achieved by a textile light-protection material comprising at least one microfilament non-woven fabric having a surface weight of 20 to 300 g/m², wherein the non-woven fabric comprises composite filaments which are melt-spun and plaited into a non-woven fabric having a titer of 1.5 to 5 dtex and at least 80% of the composite filaments are split into elementary filaments having a titer of 0.05 to 2.0 dtex and are solidified, wherein the elementary filaments comprise at least one crystallization agent selected from titanium dioxide, silicon dioxide, magnesium silicate hydrate, in particular in the form of talc, and/or aluminum silicate, in particular in the form of kaolin, in each case in an amount of 0.2 to 5 wt. %, more preferably 0.2 to 4.5 wt. %, more preferably 0.2 to 4 wt. %, more preferably 0.2 to 2 wt. %, more preferably 0.2 to 1.5 wt. %, more preferably 0.2 to 1 wt. %, and in particular 0.3 to 0.8 wt. %.

Amounts of 0.3 to 1.5 wt. %, 0.4 to 1.4 wt. % or 0.7 to 1.1 wt. % are likewise suitable.

Surprisingly, according to the invention it has been found that a light-protection material of this type is virtually impermeable to UV light and is also extremely mechanically stable, even with small amounts of the crystallization agent and at surface weights of less than 300 g/m². The invention uses the term “UV light” in the conventional sense. In particular, UV light includes light having wavelengths of 100 nm to 380 nm (cf. DIN 5031, Part 7). Against this background, a preferred embodiment of the invention includes the use of the microfilament non-woven fabric as a UV light-protection material.

According to the invention, the surface weights of the light protection material are 50 to 300 g/m², preferably 35 to 200 g/m², and in particular 80 to 170 g/m².

Without committing to a specific mode of action, it is suspected that the crystallization agent harmonizes the alignment of the polymers during the manufacture of the composite filaments and increases the reflective area in the microfilament non-woven fabric. In addition, it is suspected that binding the crystallization agent in the non-woven fabric leads to an extremely homogeneous distribution in the light-protection element, making particularly good light protection possible. This effect is promoted by the many fiber layers in the non-woven fabric (approximately 40 fiber layers per 100 g/m²) and by the fact that the split filaments, which in each case have two planar faces at an acute angle to one another as a result of the splitting, provide a large total reflective area in relation to the specific surface area thereof.

According to the invention, it is particularly preferred to use titanium dioxide, which is preferably used in the form of particulate titanium dioxide. Practical experiments have shown that particularly good light protection becomes possible when using titanium dioxide of which more than 50 wt. % is in the form of the anatase modification and/or which has an average particle size of 20 nm to 1 μm. The use of CLARIANT RENOL ATDX 30 titanium dioxide is even more strongly preferred. The isotropic thread distribution in the non-woven fabric means that purling and taking into account the machine running direction are not necessary. As a result of the continuous filaments, the textile light-protection material does not exhibit fraying. Chemical finishing is not necessary. However, the advantageous properties of the non-woven fabric may be combined with further advantageous properties by using suitable chemical finishing, such as in particular hydrophilia, hydrophobia, flame-proofing or anti-soil finishes or metal coatings.

However, good results are also obtained with silicon dioxide, magnesium silicate hydrate, in particular in the form of talc, and/or aluminum silicate, in particular in the form of kaolin, as the crystallization agent.

It is conceivable for all of the elementary filaments to contain the crystallization agent. This has the advantage that particularly effective sun protection can be achieved. However, the crystallization agent may also only be present in selected elementary filaments. If the composite filaments are for example bicomponent continuous filaments, it is conceivable for the crystallization agent merely to be present in one of the two components of the bicomponent continuous filament. If for example a light-protection material made of a bicomponent continuous filament containing polyester, preferably polyethylene terephthalate, and/or polybutylene terephthalate, is manufactured as the first component, and polyamide, preferably polyamide 6 polyamide 66, polyamide 46, polyamide 6, is manufactured as the second component, the crystallization agent may be present in both components as described above. However, it is also conceivable for the crystallization agent merely to be added to the first or the second component.

A particularly preferred embodiment of the invention comprises a light-protection material made of a bicomponent continuous filament, the first component containing polyester, preferably polyethylene terephthalate, and/or polybutylene terephthalate, and the second component preferably containing polyamide, preferably polyamide 6, polyamide 66, polyamide 46, and the first component containing the crystallization agent in an amount of 0.2 to 5 wt. %, more preferably 0.2 to 4.5 wt. %, more preferably 0.2 to 4 wt. %, more preferably 0.2 to 2 wt. %, more preferably 0.2 to 1.5 wt. %, more preferably 0.2 to 1 wt. %, and in particular 0.3 to 0.8 wt. %, and the second component containing the crystallization agent in an amount of less than 0.1 wt. %, preferably at a level of less than 0.05 wt. %.

Surprisingly, according to the invention it has been found that the addition of the crystallization agent specifically to the polyester-containing component is particularly effective for increasing UV protection. This makes it possible to omit the addition of crystallization agent to the polyamide-containing component, and this simplifies the method as well as being advantageous for reasons of cost.

Preferably, the textile light-protection material is one in which the non-woven fabric having surface weights of 35 to 200 g/m² consists of melt-spun, aerodynamically stretched composite filaments having a titer of 1.5 to 3 dtex which are plaited directly into a non-woven fabric, and at least 80% of the composite filaments are split into elementary filaments having a titer of 0.05 to 1.0 dtex and are solidified.

Particularly good results are obtained if the composite filaments have a titer of 0.8 to 4, preferably 1.4 to 2.6, more preferably 1.6 to 2.4 dtex and/or if at least 85%, in particular 90%, more preferably at least 95% of the composite filaments are split into elementary filaments and solidified, the titer of the elementary filaments preferably being 0.01 to 0.3 dtex, preferably 0.03 to 0.2 dtex, in particular 0.05 to 0.15 dtex.

Preferably, the textile light-protection material is one in which the multi-component continuous filament is a bicomponent continuous filament made of at least two incompatible polymers. A bicomponent continuous filament of this type is easy to split into elementary filaments and leads to a good strength-to-surface-weight ratio. At the same time, the textile light-protection material according to the invention is crease-resistant, easy to wash and fast-drying, in other words low-maintenance, because of the polymers used and the filament structure thereof.

If bicomponent continuous filaments are used as composite filaments, the weight ratio between the first and second components is preferably 60:40, more preferably 70:30, a polyester, in particular polyethylene terephthalate, being used as the first component. According to the invention, a polyamide, in particular polyamide 6, is preferably used as the second component.

The proportion of composite filaments or elementary filaments in the textile light-protection material is preferably at least 50 wt. %, in particular 60 to 100 wt. %.

Preferably, the textile light-protection material is one in which the composite filaments have a cross section with an orange-like or “pie” multi-segment structure, the segments containing different, alternately incompatible polymers. Hollow pie structures are also suitable, and may also have an asymmetrically axially extending cavity.

The orange segment or cake-slice arrangement (pie arrangement) advantageously has 2, 4, 6, 16, 32 or 64 segments, particularly preferably 16, 24 or 32 segments.

Thermoplastic polymers, in particular what are known as incompatible polymer pairs or blends, of different polyolefins, polyesters, polyamides and/or polyurethanes in any desired combination, are preferably used as the polymers, and preferably result in pairs which do not bond, or only do so with difficulty or under particular conditions.

In this context, a substantially non-bonding connection means a connection with no bonding, with difficulty in bonding or with conditional bonding. Thus, materials with conditional bonding have conditional or non-existent diffusion bonding, but have good adhesion bonding under some circumstances, and materials with difficulty in bonding have no diffusion bonding and conditional adhesion bonding if any.

According to the invention, incompatible polymer pairs or blends mean that the individual components have a low adhesion to one another and are thus easy to split.

The polymer pairs used are particularly preferably selected from polymer pairs comprising at least one polyolefin, preferably comprising polyethylene, such as polypropylene/polyethylene, polyamide 6/polyethylene or polyethylene terephthalate/polyethylene, or comprising polypropylene, such as polypropylene/polyethylene, polyamide 6/polypropylene or polyethylene terephthalate/polypropylene.

Polymer pairs comprising at least one polyamide or comprising at least one polyethylene terephthalate are preferred because of the conditional bonding thereof, and polymer pairs comprising at least one polyolefin are particularly preferably used because of their difficulty in bonding.

As particularly preferred components of the multi-component continuous filament, polyesters, preferably polyethylene terephthalate and/or polybutylene terephthalate, on the one hand, polyamide, preferably polyamide 6, polyamide 66, polyamide 46, on the other hand, optionally in combination with one or more further polymers incompatible with the aforementioned components, preferably selected from polyolefins, have been found to be particularly expedient.

Preferably, the textile light-protection material is in addition one in which at least one of the incompatible polymers forming the multi-component continuous filament comprises polyethylene terephthalate, on the one hand, and at least a further one of the incompatible polymers forming the multi-component continuous filament comprises a polyamide, preferably polyamide 6. This combination exhibits excellent splitting.

Aside from this orange-like multi-segment structure of the composite filaments, a side-by-side (s/s) segment arrangement of the incompatible polymers in the multi-component continuous filament is also possible, and is preferably used to produce curly filaments. Segment arrangements of this type of the incompatible polymers in the multi-component continuous filament have been found to have very good splitting. The textile light protection material has a very favorable ratio of surface weight to UV light-absorption capacity, and so highly effective light-protection materials can be produced therefrom even with a low use of material.

The light-protection material may further comprise suitable additives. The additives may for example reduce or prevent static charges. The textile light-protection material has very good maintenance properties in terms of washability and low drying time, in particular when used as a garment, drape or blind.

The light-protection material can be produced by a method having the following steps:
composite filaments are spun from at least two polymer melts, the first polymer melt containing at least a first polymer and the second polymer melt containing at least a second polymer incompatible with the first polymer, and at least one polymer melt containing a crystallization agent, selected from titanium dioxide, silicon dioxide, magnesium silicate hydrate, in particular in the form of talc, and/or aluminum silicate, in particular in the form of kaolin, in each case in an amount of 0.2 to 5 wt. %, more preferably 0.2 to 4.5 wt. %, more preferably 0.2 to 4 wt. %, more preferably 0.2 to 2 wt. %, more preferably 0.2 to 1.5 wt. %, more preferably 0.2 to 1 wt. %, and in particular 0.3 to 0.8 wt. %, amounts of 0.3 to 1.5 wt. %, 0.4 to 1.4 wt. % or 0.7 to 1.1 wt. % likewise being suitable.
the composite filaments are stretched and plaited into a non-woven fabric,
the non-woven fabric is solidified by high-pressure fluid jets and split into elementary filaments having a titer of 0.05 to 2.0 dtex.

The textile light-protection material thus obtained is very uniform in thickness. It has an isotropic thread distribution, does not have any tendency to delaminate, and is distinguished in particular by high moduli in particular if non-curly filaments are used.

It is conceivable to add the crystallization agent to all of the polymer components. For example, it may be added by introducing a master batch, containing crystallization agent, into the polymer melt. This has the advantage that the distribution of the crystallization agent is very homogeneous, and so particularly effective sun protection can be achieved. Moreover, as regards the method, it is advantageous that the presence of crystallization agent improves the recrystallization of the polymer melts. Rapid recrystallization is advantageous because it reduces the number of filament breaks during stretching. In this way, irreparable faults can be prevented during manufacture of the material. Rapid recrystallization further prevents the polymer melts from diffusing into one another and thus makes splitting easier.

However, it is also conceivable for the crystallization agent only to be added to selected polymer components. Thus, when the textile light-protection material is being manufactured from bicomponent continuous filaments, it is conceivable for crystallization agent merely to be added to one of the two components for the bicomponent continuous filament. For example, if a light-protection material is manufactured from a bicomponent continuous filament made of polyamide 6 and polyethylene terephthalate, the crystallization agent may be added to both components as described above. However, it is also conceivable for the crystallization agent merely to be added to the polyamide 6 or the polyethylene terephthalate. This embodiment has the advantage that the bicomponent continuous filament has a particularly stable structure.

According to a particularly preferred embodiment of the invention, the crystallization agent is added to the polymer component which contains the polyester, in particular the PET, the crystallization agent being added to the polyester component in particular in an amount of 0.2 to 5 wt. %, more preferably 0.2 to 4.5 wt. %, more preferably 0.2 to 4 wt. %, more preferably 0.2 to 2 wt. %, more preferably 0.2 to 1.5 wt. %, more preferably 0.2 to 1 wt. %, and in particular 0.3 to 0.8 wt. %, in each case based on the total weight of the polymer component. By contrast, preferably no crystallization agent is added to the polymer component which contains the polyamide, in particular the polyamide 6, in such a way that this component preferably contains the crystallization agent in an amount of less than 0.1 wt. %, in particular less than 0.05 wt. %.

The crystallization agent is preferably introduced into the polymer melt by means of a previously compounded master batch of 10-50, preferably 20-40 wt. % TiO₂ in PET.

Advantageously, the method for manufacturing the textile light-protection material is carried out in such a way that the composite filaments are solidified and split in that high-pressure fluid jets, preferably high-pressure water jets, are applied to the optionally pre-solidified non-woven fabric at least once on each side. The textile light-protection material thus has a textile surface and a splitting level of the composite filaments of more than 80%.

To facilitate the separation of the multi-component elementary filaments into the elementary filaments, the composite filaments preferably comprise a central opening, in particular in the form of a tubular, elongate cavity, which can be centered on the central axis of the composite filaments. This arrangement makes it possible to reduce or prevent close contact between the elementary filaments formed by the internal angles of the gaps or circle sectors, before the separation of the elementary filaments, and contact in this region between different elementary filaments made of the same polymer material.

For further solidification of the non-woven fabric structure, the composite filaments may exhibit latent or spontaneous curling, which results from asymmetrical behavior of the elementary filaments about the longitudinal central axis thereof, this curling optionally being activated or reinforced by an asymmetrical geometric configuration of the cross section of the composite filaments.

In one variant, the composite filaments may exhibit latent or spontaneous curling brought about by a difference in the physical properties of the polymer materials forming the elementary filaments in the spinning, cooling and/or stretching processes affecting the composite filaments, which leads to twists caused by internal asymmetrical loads about the longitudinal central axis of the composite filaments, the curling optionally being activated or reinforced by an asymmetrical geometric configuration of the cross section of the composite filaments.

The composite filaments may exhibit latent curling which is activated by a thermal, mechanical or chemical treatment before the non-woven fabric is formed.

The curling may for example be thermally or chemically reinforced by an additional treatment of the solidified material. The non-woven fabric according to the invention is preferably solidified by treatment with high-pressure fluid jets. Thus, the elementary filaments may be strongly wound, by a mechanical means acting predominantly perpendicular to the plane of the material (needling, liquid pressure jets), during or after the division of the composite filaments.

The composite filaments may for example be plaited by mechanical and/or pneumatic deflection, it being possible to combine at least two of these types of deflection, and by spinning on a continuous belt and mechanically by needling or by the action of liquid pressure jets, which may be loaded with solid (micro)particles. The steps of winding and separating the composite filaments into elementary filaments may take place in a single method step and using a single device, it being possible for the more-or-less continuous separation of the elementary filaments to end with an additional process which is more focussed on the separation.

The strength and mechanical resistance of the non-woven fabric may further be greatly increased if it is provided that the elementary filaments are bonded to one another by thermofusion, which affects one or more thereof, preferably by warm calendaring with heated, smooth or engraved rollers, by passing through a hot-air tunnel oven, by passing through a drum through which hot air flows, and/or by applying a binder, which is contained in dispersion or solution or is in powder form.

In one variant, the nap may likewise be solidified for example by warm calendaring prior to any separation of the uniform composite filaments into elementary filaments, the separation taking place after the nap is solidified.

In addition, the nap microstructure may also be solidified by a chemical treatment (as disclosed for example in the applicant's French patent specification 2 546 536) or by thermal treatment, which leads to controlled shrinking of at least some of the elementary filaments after the optional separation thereof. This results in the material shrinking in the transverse and/or longitudinal directions.

Furthermore, after solidification, the non-woven fabric may be subjected to chemical bonding or finishing, such as anti-pilling treatment, hydrophilization or hydrophobization, antistatic treatment, treatment to improve fire resistance and/or to change the tactile properties or the luster, mechanical treatment such as roughening, sanforization, sanding or a tumbler treatment and/or a treatment to change the appearance, such as dying or printing.

Practical experiments have shown that a light-protection material having a particularly homogeneous structure can be obtained if the non-woven fabric is pre-solidified by applying heat and/or pressure, preferably by calendaring at a temperature of 160 to 200° C. and/or by way of a linear load of 20 to 80 n/mm.

Advantageously, the textile light-protection material according to the invention is subjected to further point calendering to increase the abrasion resistance thereof. For this purpose, the split and solidified non-woven fabric is passed through heated rollers, of which at least one roller comprises elevations which lead to the filaments fusing together at points. In a preferred embodiment of the invention, the composite filaments are dyed by spin-dying.

Because of the good haptic properties thereof, the textile light-protection material according to the invention is excellent for manufacturing parasols, outdoor curtains or roller-blinds, combined wind-protection and sun-protection materials or awnings, garments such as swimwear, sunhats, children's clothing, drapes or curtains. In this context, surface structuring or pattern formation may be carried out for example during the water-jet solidification of the multi-filament non-woven fabric by way of the selection of underlay.

Preferably, the textile light-protection material is also used for manufacturing vertical blinds or folding roller-blinds, it being possible to increase the rigidity of the material by embossed calendaring, by fusing a polymer component and/or by coating with a foamed material.

Because of the surprisingly high stability of the light-protection material according to the invention, it is outstandingly suitable for outdoor applications, for example for manufacturing parasols, outdoor curtains or roller blinds, combined wind-protection and sun-protection materials or awnings. In these applications, it is further advantageous that said material can additionally provide weather protection, for example rain protection, because of the high stability thereof. It can equally be used to reflect heat and/or as an advertising space. To improve the heat reflection, the material may be coated with a heat-reflecting material on one side, preferably aluminum, vapor-deposited or embedded in a binder. For use as an advertising space, printing may be applied on one or both sides. To improve the rain protection, the material may be finished to be water-repellent, oil-repellent and/or dirt-repellent.

In the following, the invention is described in greater detail by way of examples.

### EXAMPLE 1

### Manufacturing a Non-Woven Fabric

As disclosed in EP0814188, a non-woven fabric having 100 g/m² surface weight, a 70/30 PET/PA6 composition, an overall titer of 2.4 dtex over 16 PIE segments is deposited on a belt and split by a water-jet solidification system into individual filaments averaging 0.15 dtex, which are simultaneously entwined together. In this case, the manufacture involves PET and PA6 which each contain crystallization agent in an amount of 1 wt. %.

This microfilament non-woven fabric is dyed by jet dying and subsequently finished to be hydrophobic with a conventional commercial fluorocarbon (aqueous). The textile thus produced provides excellent UV protection, has a low surface weight, and takes up very little space when packed, and is thus outstandingly suitable as a textile sun/wind-protection device.

### EXAMPLE 2

### Manufacturing a Non-Woven Fabric

As disclosed in EP0814188, a microfilament non-woven fabric is manufactured which differs only in surface weight from Example 1. In this example, the textile has a surface weight of 170 g/m². The higher surface weight leads to an increase in the mechanical strengths by comparison with Example 1. This textile is point-calendered using a fine pattern to increase the inherent rigidity and abrasion resistance thereof. Using a doctor blade, one side of the textile is coated with a binder which contains fine aluminum particles or other light-reflecting components, preferably red-reflecting or infrared-reflecting components, such as vanadium oxides. This results in the underside of the textile being formed to reflect thermal radiation.

The other side of the textile is printed. The printing may also be preceded by dispersion dying of the PET component. The printing may be carried out by transfer sublimation, using aqueous or organic solvent or by means of aqueous binder. The quality of the dyes determines the service life of the dying or the printing, but not (indirectly) the service life or UV protection of the textile.

Subsequently, the textile is finished to be hydrophobic by impregnation or by spraying on one side (the printed side). Preferably, the impregnation is combined with the application of flame retardant and/or an oil-repellent and dirt-repellent coating.

The textile manufactured in this manner is outstandingly suitable for flexible textile sun-protection systems for direct incident solar radiation (parasol, awning). The flexibility thereof makes compact storage possible. The entire surface can be used for decoration or for information (advertising). Oil-repellent and dirt-repellent treatments ensure a long-term attractive appearance.

As described above, the underside of the textile can be made to reflect thermal radiation, and this is expedient in particular for colder times of year.

### EXAMPLE 3

### Calculating Light-Protection Areas

The light-protection material according to the invention has a very large area available for light protection in relation to the surface weight thereof. In the following, the area of a light protection material according to the invention available for light protection is calculated.

Assuming 100 g/m² non-woven fabric of the type disclosed in Examples 1 and 2 above, 0.2 dtex and 0.1 dtex for PA6, and taking complete splitting for ease of calculation, 6,600 km threads per m² results in an area of 2×6,6000,000×6.5×10⁻⁶≈86 m² which is available at least in part for total reflection. Therefore, 100 g/m² non-woven fabric made of polyethylene terephthalate (0.2 dtex) and polyamide 6 (0.1 dtex) having 6,600 km threads per m² provides a sun-protection area of approximately 86 m² for every 1 m² of non-woven fabric.

### EXAMPLE 4

### Light Protection Testing

A textile light-protection material according to the invention was analyzed for the light-protection effect thereof

### (1) Light Range

| Light | Light | Light | UV |
|---|---|---|---|
| transmission | reflection | absorption | transmission |
| τ_{v.B} | ρ_{v.B} | α_{v.B} | τ_{v.B} |
| 0.0273 | 0.7727 | 0.2000 | 0.0000 |

### (2) Solar Range

| Solar transmission | Solar reflection | Solar absorption |
|---|---|---|
| T_{e.B} | P_{e.B} | A_{e.B} |
| 0.0563 | 0.7805 | 0.1632 |

(3) Total Energy Transmittance gₜ and Reduction Factor F_{c}

| Total energy transmittance | Reduction factor |
|---|---|
| gₜ | F_{c} |
| 0.31 | 0.42 |

Remark: F_{c} and Gₜ values valid for following assumptions in accordance with DIN EN 13363-1:
double-glazing with heat insulation coating having thermal transmittance
sun protection internal, closed

The test results according to the invention shows that the transmission in the described strong UV range for the light protection element according to the invention is so low that it cannot be detected using the current test parameters.

These test results were obtained using a microfilament non-woven fabric as disclosed above having a surface weight of 170 g/m².

### EXAMPLE 5

### Light Protection Testing

In a further UV protection test procedure, a microfilament non-woven fabric as disclosed above, having 90 g/m² surface weight, was tested in accordance with a clothing standard, which assesses how long a person clothed using this textile can remain exposed to direct solar radiation compared with an unprotected person (“sun protection factor”).

The average transmission in the UVA and UVB ranges was determined for the unworn textile when new. In accordance with Australian/New Zealand Standard AS/NZS 4399:1996, an ultraviolet protection factor UPF of approximately 400 was measured. It should be noted that the evaluation scale ends at 50+, since higher light-protection factors are generally not required in view of the finite length of daylight hours.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A method of light-protecting a textile, the method comprising:
combining 0.2 to 2 wt. % of a crystallization agent with a microfilament non-woven fabric having a surface weight of 20 to 300 g/m²,
wherein the microfilament non-woven fabric comprises composite filaments having a titer of 1.5 to 5 dtex which are melt-spun and plaited into a non-woven fabric,
wherein at least 80% of the composite filaments are split into elementary filaments having a titer of 0.05 to 2.0 dtex and are solidified,
wherein the elementary filaments comprise the crystallization agent, as a textile light-protection material, and
wherein the crystallization agent comprises titanium dioxide, silicon dioxide, magnesium silicate hydrate, and/or aluminum silicate.

2. The method of claim 1, wherein an average particle size of the crystallization agent is in a range of from 20 nm and 1 μm.

3. The method of claim 1, wherein the microfilament non-woven fabric having surface weights of 35 to 200 g/m² ,
wherein the microfilament non-woven fabric comprises melt-spun, aerodynamically-stretched, composite filaments having a titer of 1.5 to 3 dtex which are plaited into a non-woven fabric, and
wherein at least 80% of the composite filaments are split into the elementary filaments having a titer of 0.05 to 1.0 dtex and are solidified.

4. The method of claim 1, wherein the composite filaments comprise a bicomponent continuous filament comprising a first polymer and a second polymer,
wherein the first polymer and a second polymer are incompatible.

5. The method of claim 1, wherein at least a portion of the composite filaments have a cross section having an orange-like multi-segment structure, segments of the multi-segment structure alternately comprising incompatible polymers, and/or
wherein at least a portion of the composite filaments have a side-by-side structure comprising incompatible polymers, and/or
wherein at least a portion of the composite filaments have hollow pie structures, which may also comprise an asymmetrically axially extending cavity.

6. The method of claim 1, wherein the composite filaments comprise a central opening along a filament axis.

7. The method of claim 4, wherein the first and/or second polymer comprises an additive comprising a color pigment, antistatic agent, antimicrobial agent, hydrophilization agent, hydrophobization additive, or a mixture of two or more of any of these, in an amount of 150 ppm to 10 wt. %.

8. The method of claim 1, further comprising:
finishing the fabric so as to make the fabric water repellant, dirt repellent, flame-retardant, dyed, printed, and/or light-reflective.

9. The method of claim 1, wherein 0.2 to 1.5 wt. % of the crystallization agent is combined.

10. The method of claim 1, wherein 0.3 to 1.5 wt. % of the crystallization agent is combined.

11. The method of claim 1, wherein 0.2 to 1 wt. % of the crystallization agent is combined.

12. The method of claim 1, wherein 0.4 to 1.4 wt. % of the crystallization agent is combined.

13. The method of claim 1, wherein the crystallization agent comprises talc.

14. The method of claim 1, wherein the crystallization agent comprises kaolin.

15. The method of claim 4, wherein the first polymer comprises polyethylene terephthalate polybutylene terephthalate, or polylactic acid, and
wherein the second polymer comprises polyamide 6, polyamide 66, or polyamide 46.

16. The method of claim 4, wherein the first polymer comprises a polyester, and the second polymer comprises a polyamide.

17. The method of claim 8, wherein the composite filaments comprise copper, silver, and/or gold.

18. The method of claim 9, wherein the fabric is made reflective of red or infrared light.

19. The method of claim 1, wherein the textile is adapted for outdoor applications.

20. A method of producing a parasol, outdoor curtain, roller-blind, a combined wind-sun-protection material, or awning, the method comprising:
carrying out the method of claim 1; and then
forming the textile into the parasol, outdoor curtain, roller-blind, combined wind-sun-protection material, or awning. talc, and/or aluminum silicate, kaolin
